(19) United States
(12) Patent Application Publication
(10) Pub. No.: US 2020/0152933 A1
(43) Pub. Date: May 14, 2020

(54) BATTERY FOR AN ELECTRIC DRIVE OF A MOTOR VEHICLE

(71) Applicant: AUDI AG, Ingostadt (DE)

(72) Inventors: Markus THURMEIER, Adlkofen (DE); Martin HEER, Koesching (DE); Norbert ENNING, Denkendorf (DE)

(73) Assignee: AUDI AG, Ingolstadt (DE)

(21) Appl. No.: 16/628,396

(22) PCT Filed: Jun. 25, 2018
(86) PCT No.: PCT/EP2018/066917

§ 371 Date: Jan. 3, 2020

(30) Foreign Application Priority Data
Jul. 4, 2017 (DE) 10 2017 211 363.4

(51) Int. Cl. H01M 2/10; B60K 1/04

(52) U.S. Cl. CPC H01M 2/1077; H01M 2/1094; B60K 2001/0438; H01M 2220/20; B60K 2001/0411; B60K 1/04

(57) ABSTRACT

A battery for an electric drive of a motor vehicle, including a plurality of battery modules which are arranged in an associated layer and are accommodated in at least one associated battery housing. In order to produce a battery which is optimized both in terms of its manufacture and also in terms of sealing tightness and properties in the event of a crash, the battery housing is accommodated in a protective housing of the battery.

The invention relates to a battery for an electric drive of a motor vehicle according to the preamble of claim 1. The invention further relates to a protective housing for such a battery as well as a motor vehicle having such a battery.

Most batteries for electric drives of motor vehicles today are installed in the underfloor area of the passenger compartment. Examples of such type of installation are found in DE 10 2012 015 919 A1 and DE 10 2015 014 033 A1, in which respective battery modules, themselves each comprising a plurality of interconnected battery cells, are arranged in a layer and/or level and accommodated in a battery housing. These known design types are extremely expensive not least because of the necessary active cooling with a coolant. In addition, the significant dimensions of the battery mean limitations with respect to the design and production engineering, because the battery housings are typically relatively difficult to seal.

Furthermore, DE 10 2013 106 433 A1 discloses a battery, wherein two battery modules, in which a plurality of interconnected battery cells are typically combined, are arranged in different layers above one another in the vertical direction of the vehicle. The two battery modules in this case are accommodated in a common battery housing, which extends over the height of both layers of battery modules. In addition, a stiffening element extends between the two battery modules, for example in the form of a horizontal intermediate plate and/or intermediate level, which connects the respective opposite housing parts to one another and hereby is intended to facilitate a block formation of the battery housing in the event of an impact in the front area of the vehicle.

However, in order to form such a battery housing that is accordingly sealed for battery modules arranged above one another in several layers and/or to provide said housing with sufficient stability and stiffness with respect to an impact force caused by an accident, significant design and accordingly expensive measures are necessary. In addition, with an impact force caused by an accident, the sealing tightness of the battery housing can only be ensured with great design effort.

Thus, the object of the present invention is to obtain a battery and/or a protective housing for a motor vehicle having such a battery, which are optimized, on one hand, in terms of their manufacture but, on the other hand, also in terms of sealing tightness and properties in the event of a crash.

This object is achieved according to the invention by means of a battery and/or protective housing as well as a motor vehicle having such a battery according to claims 1, 9, and 10. Advantageous designs with favorable refinements of the invention are the subject matter of the dependent claims.

In order to obtain a battery which is optimized both in terms of its manufacture as well as in terms of sealing tightness and properties in the event of a crash, the at least one battery housing according to the invention, within which the assigned plurality of battery modules of the corresponding layer is arranged, is accommodated in a protective housing of the battery. In this case, the battery modules comprise particularly a respective plurality of battery cells. According to the invention, a functional separation is accordingly provided between the battery housing and the protective housing, wherein the battery housing and/or a stack of battery housings is formed primarily to preferably accommodate the battery modules in a seal-tight manner and the protective housing is formed primarily to enclose the at least one battery housing, in order to protect said housing particularly from excessive damage upon impact force to the battery caused by an accident.

The division into two housings—the at least one battery housing and the protective housing—in this case enables a significant simplification in terms of manufacture. Thus, the respective battery housing can be relatively simply manufactured and optimized in terms of its sealing function, because its protective function for the battery modules is at least partially no longer necessary and/or is taken over by the protective housing in the event of an impact force caused by an accident. Conversely, the protective housing can be manufactured from relatively simple plates connected to one another via simple connection technologies or the like, because the protective housing does not have to be sealed off, for example, due to the sealing tightness of the at least one battery housing, but instead the focus of the protective housing is substantially the protection of the at least one battery housing.

The protective housing in this case provides the further option of dual usage, namely to protect the respective battery housing and to stiffen the respective areas of the vehicle body, for example the structure of the front end of the vehicle.

The battery can be used both with a purely electrically driven motor vehicle as well as with a hybrid vehicle. In this case, several batteries may optionally be installed for the drive within the motor vehicle.

In an advantageous design of the invention, the protective housing in this case has a base, which is formed as a shear panel in the underfloor area of the motor vehicle, particularly the front end of the vehicle. Thus, an additional component can be integrated in the protective housing without extensive additional expense in order to stiffen the front end of the vehicle. Driving dynamics can thus be further increased. In this case, essentially no additional costs must be considered, because this is an integral component of the protective housing.

In a further design of the invention, a battery is especially advantageous, the battery modules of which each comprise a plurality of interconnected battery cells and are arranged above one another in at least two or more layers in the vertical direction of the vehicle. This arrangement first enables a compact design of the battery such that it can particularly, but not exclusively, be installed in the front area of the vehicle and/or in the area of the front structure/crumple zone of the motor vehicle.

In this case, it is provided that each of the battery module layers arranged above one another is accommodated in a respectively assigned, separate battery housing, which are arranged above one another in a stack and are interconnected and/or connected to one another. Thus, each layer of the battery modules is accommodated in a separately producible battery housing. This offers the significant advantage that such a battery housing can be manufactured extremely economically, because it is thus designed to be substantially smaller as compared to the prior art. At least a quantity of these battery housings in this case can be formed preferably at least substantially as a common part, which significantly simplifies production. The quantity of battery housings respectively used, which corresponds to the quantity of layers of the battery modules, can then be arranged above one another in a stack, wherein, for example, the respectively adjacent battery housings are connected to one another via corresponding connection elements. The particular advantages of this simple design of the respective battery housings is seen not only in the simple production, but also in the correspondingly simple possibility of achieving a corresponding leak-tightness and also in terms of behavior in an accident, due to the greater variability in the arrangement of the battery housings above one another. In this case, the stack of battery housings can be designed as extraordinarily shear-resistant through suitable measures. In this context, it has been shown to be further advantageous when the stack of battery housings is formed as sealed. Depending on the design of the battery housing, this can occur in the simplest case in that each of these battery housings is sealed in isolation. Conversely, if passages, for example, are provided within the respective battery housing in order to connect the battery modules of various layers within the respective battery housing to one another, the battery housings can thus also be sealed off with respect to one another in a simple manner. Because the predominant sealing—with the exception of the possible passages—can occur for each battery housing, this is much simpler than the large battery housings according to the prior art.

The thusly formed stack of battery housings in this case is surrounded by the protective housing according to the invention. Because it preferably has no sealing function, this protective housing does not have to be designed correspondingly closed but can also be partially open. Because such type of sealing function is preferably not necessary, the protective housing can correspondingly be designed simply and particularly can be optimized in terms of the stability and stiffness of the battery, especially in terms of its behavior in an accident. To this end, the protective housing may be at least partially formed by corresponding side panels or similar elements, which have a corresponding absorption capacity for energy in the event of a crash. In an alternative embodiment, it would, however, theoretically also be conceivable to form such a protective housing in a sealing manner.

A further advantageous embodiment of the invention provides that the respective battery housing is formed from a plastic, particularly a fiber-reinforced plastic. A battery housing produced from such a plastic is not only economical and easy to produce, but also corresponding functional elements can be molded onto said housing in a simple manner for stiffening, for connection to other components or the like.

In a further design of the invention, the respective battery housing is formed with two layers, with a base element and a cover element. This not only enables a simple design and production of the battery housing, but moreover an easy connection of the base element of the one battery housing to the cover element of the other battery housing arranged underneath, while providing the at least one connection element, by means of which the correspondingly assigned battery module is also connected to the two battery housings and/or their base/cover element.

A further advantageous embodiment of the invention provides that at least a quantity of the battery housings arranged in stacks above one another—at least substantially—are formed with an identical shape. Identical shape in this case should be understood particularly to mean that all battery housings and/or their respective components can be produced in the same shape, for example mold. The costs of the battery can hereby be significantly reduced due to the common parts.

Finally, it has been shown to be advantageous when the respective battery housing has corresponding fastening elements for fastening respective side panels or similar protective elements of the protective housing of the battery. The side panels or similar protective elements can hereby be established on the battery in an especially simple manner.

The previously described advantages in connection with the battery according to the invention likewise apply to the protective housing according to the invention in accordance with claim 9 as well as the motor vehicle in accordance with claim 10.

Exemplary embodiments of the invention are described in the following. The following is shown:

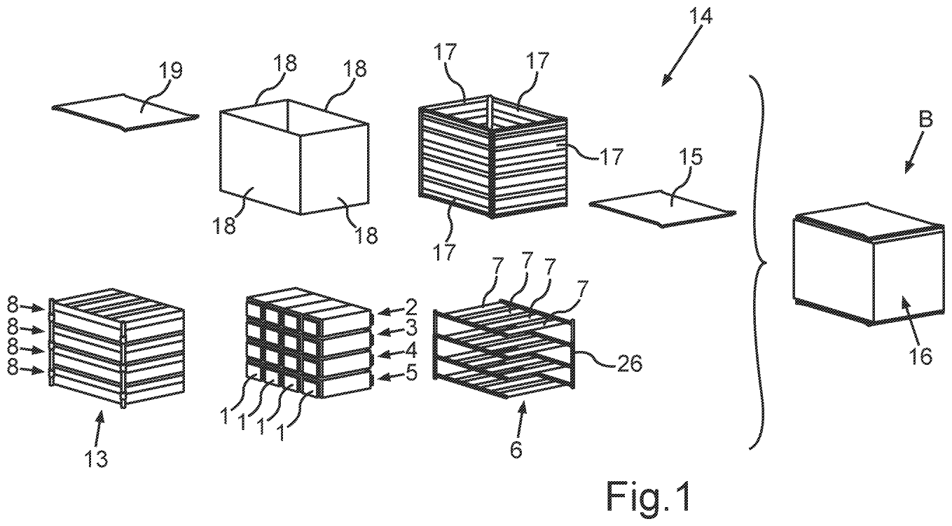

FIG. 1 a perspective exploded view of the essential components of the battery according to the invention in accordance with an advantageous embodiment;

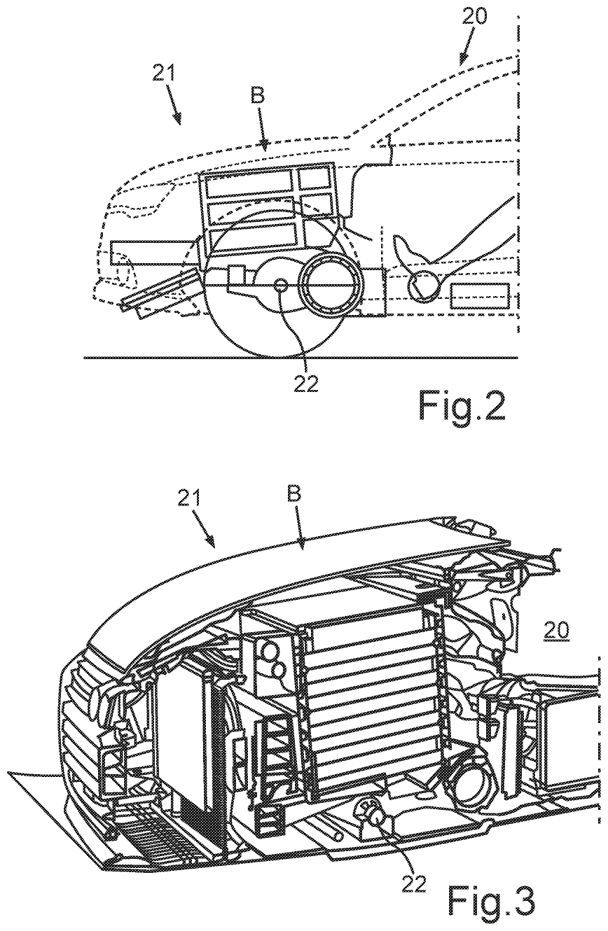

FIG. 2 a schematic and cutout sectional view of the battery installed in the front end of a motor vehicle according to an advantageous embodiment;

FIG. 3 a schematic and cutout sectional view along a sectional plane, extending in the vertical direction of the vehicle and in the longitudinal direction of the vehicle, of the battery installed in the front end of a motor vehicle according to an advantageous embodiment;

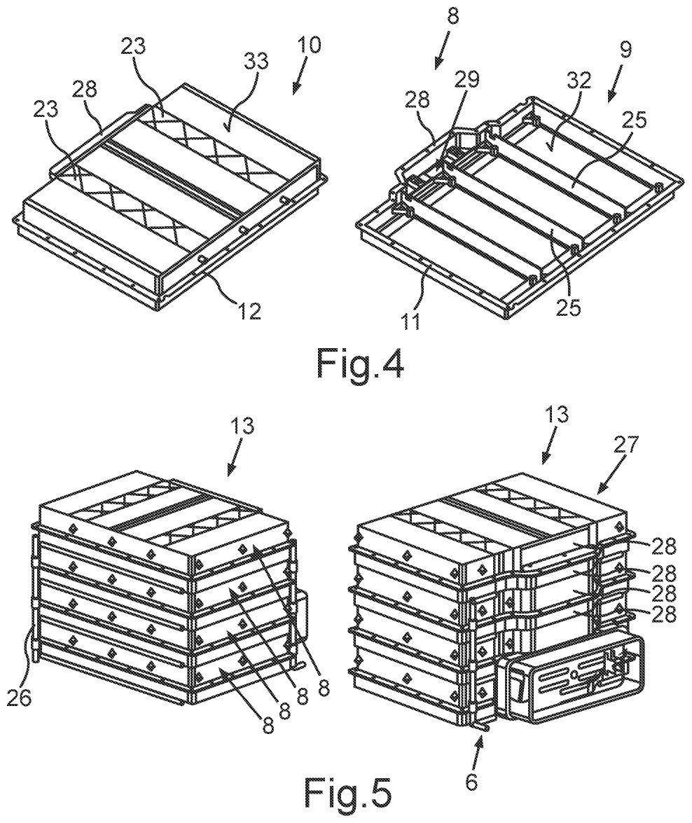

FIG. 4 a perspective view of a base element and a cover element of one of the battery housings of the battery according to the invention;

FIG. 5 respective perspective views of the battery according to an advantageous embodiment, wherein a plurality of battery housings, in each of which a plurality of battery modules is accommodated, are arranged in a stack above one another and interconnected;

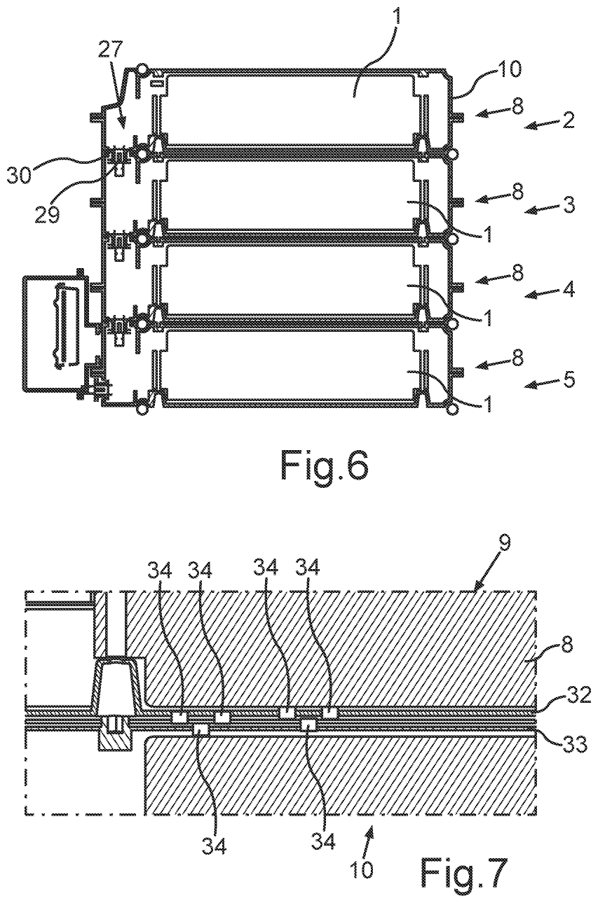

FIG. 6 a sectional view through the stack of battery housings of the battery, said housings being arranged above one another, according to an advantageous embodiment;

FIG. 7 a cutout and enlarged, schematic sectional view of a base element and a cover element of respective battery housings arranged above one another, wherein each of the components comprises respective plug connection elements, by means of which the adjacent battery housings can be positioned relative to one another and mutually supported in the direction of thrust;

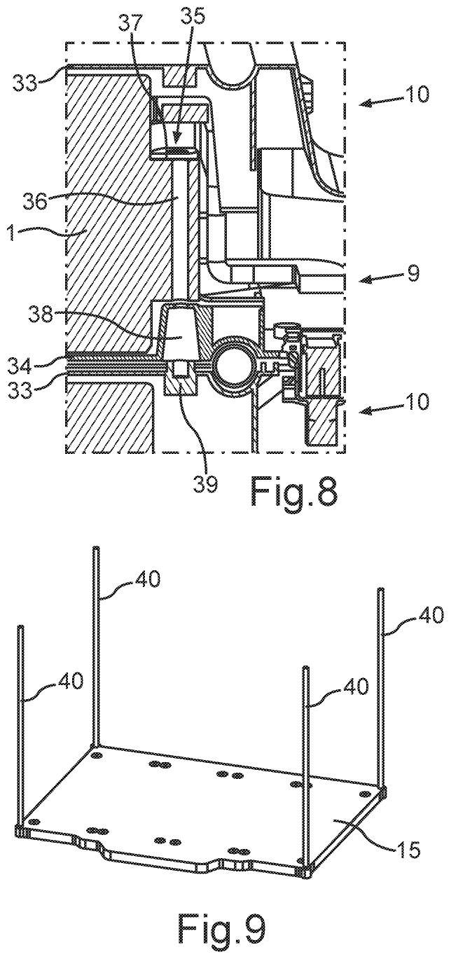

FIG. 8 a cutout and enlarged sectional view of respective battery housings adjacent one another in the area of a connection element, by means of which, on one hand, a battery module can be affixed within the corresponding battery housing and, on the other hand, the battery housing can be connected to the adjacent battery housing arranged underneath;

FIG. 9 a perspective view of a base plate of a protective housing of the stack of battery housings, in the corner region of which respective tie rods are provided to retain the stack of battery housings and/or the protective housing;

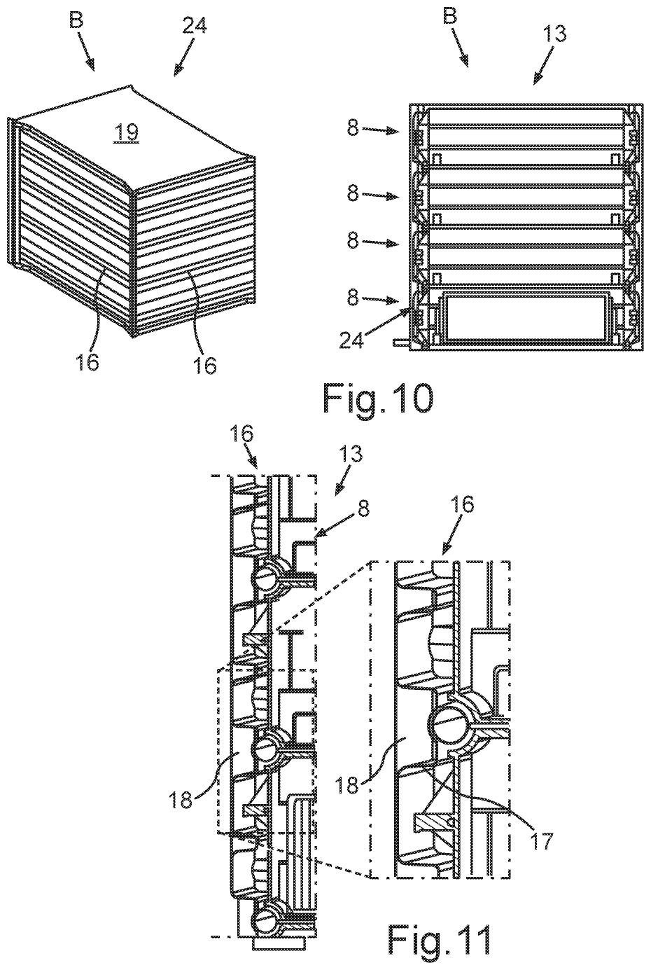

FIG. 10 a perspective view as well as a sectional view of the protective housing, within which the stack of battery housings is accommodated;

FIG. 11 a sectional view as well as an enlarged cutout of said sectional view of a side panel of the protective housing.

The exemplary embodiments explained in the following refer to preferred embodiments of the invention. With the exemplary embodiments, the described components of the embodiments represent individual features of the invention that are to be considered independently of one another, each of which also further develop the invention independently of one another and thus also are to be considered individually or in a combination that is different than the one shown as a component of the invention. Furthermore, the described embodiments can also be supplemented through further described features of the invention.

In the figures, elements which are functionally equivalent are each given the same reference numerals.

FIG. 1 shows, in a perspective exploded view, the essential components of a battery B, which is additionally shown as installed, to the right in a schematic perspective view. In this case, the battery B first comprises a plurality of battery modules 1, of which, in the present case, four pieces, for example, are arranged next to one another in a horizontal plane and/or in the vertical direction of the vehicle at a common height in a corresponding layer 2, 3, 4, 5. In other words, there are four battery modules 1 arranged here at the same height and/or within a corresponding layer 2, 3, 4, 5, wherein the plurality of said layers 2, 3, 4, 5 are arranged above one another in a manner described in more detail in the following. Each battery module 1 is formed by a plurality of battery cells interconnected in parallel and/or in series. The output voltage of the respective battery module 1 is consequently correspondingly greater than the output voltage of the respective plurality of corresponding battery cells. The output voltage of the entire battery B is accordingly greater than that of the respective battery modules 1 that are correspondingly interconnected.

Furthermore, the battery B comprises a cooling device 6, which is described in greater detail in the following, and within which coolant circulates. The cooling device 6 in this case comprises a plurality of flat cooling elements and/or cooling lines 7, of which four extend on a common plane or in one plane. The cooling elements and/or cooling lines 7 in this case extend on the underside of the corresponding battery module 1 or underside of the respective layer 2, 3, 4, 5 of battery modules 1 in a manner which is described in greater detail in the following.

The respective layer 2, 3, 4, 5 of battery modules 1 in this case is accommodated within a respectively assigned battery housing 8, such as one shown in FIG. 3 in a respective perspective view of a base element 9 and of a cover element 10 of the battery housing 8. After being populated with the respectively associated four battery modules 1 of the corresponding layer 2, 3, 4, 5, the base element 9 and the corresponding cover element 10 in this case are sealed in the area of respective flanges 11, 12 assigned to one another with the provision of a seal, which is not shown in greater detail. Because four layers 2, 3, 4, 5 of battery modules 1 are provided in the present case, accordingly four corresponding battery housings 8 are arranged above one another in a stack 13, which is shown in FIG. 1. In this case, the respective battery housings 8 are positioned reciprocally and connected to one another or interconnected in the manner as described in the following.

The stack 13 of battery housings 8 with the cooling device 6 is accommodated in a protective housing 14, which is shown in an exploded view as well in FIG. 1. Said protective housing 14 first comprises a base 15 as well as four respective side panels 16, which are composed of two parts and/or layers 17 and 18 in this case. In the present case, these two parts are, for example, a corrugated sheet 17 and a corresponding locking plate 18, in order to achieve a multilayered component with good energy absorption. In addition, the protective housing 14 comprises a cover 19 such that the stack of battery housings 8 in this case is completely enclosed by the protective housing 14. The protective housing 14 here is also characterized as crash-resistant armor and is shown again to the right in FIG. 1 in the assembled form in a corresponding perspective view.

In a schematic sectional view or in a schematic and cutout sectional view along a sectional plane extending in the vertical direction of the vehicle and in the longitudinal direction of the vehicle, FIG. 2 and FIG. 3 show a front end 21 of a vehicle arranged in front of a passenger compartment 20 and/or front structure/crumple zone of a passenger car, in which region the battery B is arranged.

In this case, the battery B is retained, in a manner that is not shown in greater detail otherwise, at a height above a front axle 20 of the motor vehicle on corresponding components of the body or on subframe elements, which are attached to the car body shell. The battery B is incorporated into the crash-avoidance systems of the vehicle here. It is particularly clear that the battery B installed in the front end 21 of the vehicle can be installed similarly to a combustion engine and/or instead of said combustion engine due to the very good position. The tall structure of the battery B with the several layers 2, 3, 4, 5 of battery modules 1 in the corresponding battery housings 8 and the arrangement thereof above one another into a stack 13 provides the possibility of utilizing the installation space that is used in motor vehicles with combustion engines in an optimal manner. The stack 13 of the battery housings 8 in this case is protected by the protective housing 14 in an optimal manner.

The respective battery housing 8 and/or the individual parts thereof, which are the base element 9 and the cover element 10 in the present case, are formed from a plastic, particularly a fiber-reinforced plastic, and produced, for example, in an injection-molding process. The use of plastic in this case not only has the advantage of simple and economical production of the battery housings 8 designed with an identical shape, but also functional elements such as, for example, elements/ribs of a stiffening structure 23 and/or plug connection elements 24 (FIG. 7) can be provided, in a simple manner, to connect the battery housing 8 to the adjacent battery housing 8. In addition, plastic is especially suitable for integrating stiffening elements such as inlays, threaded sleeves, or the like but also functional elements of the cooling device 6 into the respective battery housing.

The stiffening structure 23 with the ribs in this case is provided particularly for corresponding load cases in the event of an impact force caused by an accident. The flanges 11, 12 of the base element and of the cover element 9, 10 are formed, for example, in a standard shape and connected to one another via screws.

Furthermore, FIG. 4 shows that, due to the respective bars 25, corresponding surfaces within the base and the cover element 9, 10 are subdivided, within which the respective battery modules 1 are accommodated.

FIG. 5 shows two respective perspective views of the plurality of, in this case, four battery housings 8, in each of which the plurality of battery modules 1 is accommodated and which are arranged above one another in a stack 13 and are interconnected. In addition, the partial integration of the cooling device 6 in the stack 13 of the battery housings 8 can be seen here. In this case, the flat cooling lines and/or cooling elements 7 are arranged on the underside of the respective battery housing 8 or between two adjacent battery housings 8 arranged above one another. Individual cooling elements 7 in this case are connected via supply lines 26, which extend, for example, in the corner region of the stack 13. The supply lines 26, which are designed as riser cables, have throttles here. In addition, the plug connections between the components of the cooling device 6 are optimized in terms of flow resistance.

On its back side, the stack 13 of battery housings 8 has a contiguous channel 27, which connects the interior of the respective battery housings 8 to one another. Said channel is formed by a respectively shaped front panel 28, shown in FIG. 3, in the base and cover element 9, 10 of the respective battery housing 8, wherein, in addition, a passage 29, by means of which the channel 27 is formed, is formed in the respective base element and cover element 9, 10.

To ensure that the entire stack 13 of battery housings 8 is self-contained—as can be seen in the sectional view through the stack 13 according to FIG. 6—a seal 31 is provided between the edge area 30 of the passage 29 of the one battery housing 8 and the edge area 30 of the passage 29 of the adjacent battery housing 8. The seal 31 may be formed, for example, by means of a threaded insert or threaded socket through the respective passages 29 or by means of a seal, which is inserted between the battery housings 8. The end result, in any case, should be that the edge area 30 of the passage 29 of the one battery housing 8 is sealed off from the edge area 30 of the passage 29 of the adjacent battery housing 8 with the seal 31.

In particular, the respective layers 2, 3, 4, 5 of battery modules 1 are interconnected via the channel 27. In this case, a strip- or bar-like conductor, for example, may extend within the channel 27. Passages 29 that are not required, for example on the bottom of the bottommost or top of the uppermost battery housing 8 of the stack 13, can be closed off, for example, by a plug.

FIG. 7 shows a cutout and enlarged, schematic sectional view of the base element 9 of one of the battery housings 8, which rests, with a base plate 32, on a cover plate 33 of the battery housing 8 arranged underneath. In this case, exemplary plug connection elements 34 protrude downward from the base plate 32, said plug connection elements interacting with further plug connection elements 34 protruding upward from the cover plate 33 such that the adjacent battery housings 8 are connected and positioned relative to one another. Assembly of the stack 13 of battery housings 8 can hereby be greatly facilitated. In addition, forces, particularly shear forces, can be transferred between the adjacent battery housings 8 via the plug connection elements 34 in the event of an impact force caused by an accident.

Thus, the stiffness of the battery B can be significantly improved in this manner by the shear-resistant connection of the battery housings 8. The plug connection elements 34 may be, for example, latches, blockers, domes, clips, or the like.

FIG. 8 shows a cutout and enlarged sectional view of two battery housings 8 adjacent one another in the area of a connection element 35. The connection element 35 in this case comprises a sleeve 36, which pushes through the respective battery module 1 in the vicinity of its front panel extending in the vertical direction of the battery B. A screw element, which is not discernible here, extends within the sleeve 36, said screw element being supported on the top side of the sleeve 36 on a plate 37 of the battery module 1 with a head, and said plate being durably connected to the sleeve 36. The sleeve 36 and/or the battery module 1 rests on the bottom side on a dome part 38, which is accommodated in an equivalently shaped mount in the plastic of the base plate 32 of the base element 9.

A threaded sleeve 39 is connected below, which is integrated and/or molded in this case in the plastic of the cover plate 33 of the cover element 10. The previously described threaded element is screwed into said threaded sleeve 39. When the screw element is tightened, the battery module 1 is tensioned downward against the base element 9 and against the dome part 38, which is supported on the cover plate 33 of the cover element 10 of the battery housing 8 positioned underneath. In this case, the cover element 10 and the battery module 1 are centered and fixed in position, relative to the cover plate 33 of the cover element 10 of the battery housing 8 positioned underneath, by means of the dome part 38.

In order to prevent a duplicate fit, there is clearance provided between the bottom side of the battery module 1 and of the base plate 32 of the base element 9, which is filled, for example, with a filler. By tightening the screw element, the battery module 1 with the base element 9 and also the cover element 10 are thus tensioned. In the present case, there are two connection elements 35 provided per front side 41 of each battery module 1, i.e. a total of four connection elements 35 per battery module 1, and sixteen connection elements 35 per layer 2, 3, 4, 5 of battery modules 1. However, it is obvious that this quantity may vary depending on the design, which depends, for example, on the number of layers 2, 3, 4, 5 or on the size of the individual battery housing 8.

FIG. 9 shows a perspective view of the base plate and/or of the base 15 of the protective housing 14, by means of which the stack 13 of battery housings 8 is enclosed. Extending in the vertical direction of the vehicle, there are respective tie rods 40 provided in the corner regions of the base plate 15, said tie rods retaining the stack 13 of battery housings 8 and/or the protective housing 14, which are screwed into the base 15. Moreover, the tie rods 40 can be used to install or remove the battery B in that crane hangers, for example, are screwed onto the top. Thus, the battery B, along with its protective housing 14, can be removed from or installed in the motor vehicle. In addition, respective threaded sleeves 39 or threaded holes are integrated in the base plate 15, which take on the functions, described above in connection with FIG. 8, of retaining the base element 9 arranged above and/or the battery modules 1 accommodated by the battery housing 8 thereof. The base 15 here is formed as a metal plate, for example, made of an aluminum alloy.

Finally, FIG. 10 shows a perspective view as well as a sectional view of the protective housing 14, within which the stack 13 of battery housings is accommodated. When viewed together with FIG. 11, which shows one of the side panels 16 of the protective housing 14 in a sectional view as well as in an enlarged cutout of said sectional view, it can be seen that the four side panels 16 are formed from the corrugated sheet 17 on the inside and formed from the flat locking plate 18 on the outside in order to thus form the multilayered component with good energy absorption.

The side panels 16 and/or the respective components 17, 18 thereof are produced here from sheets based on an aluminum or steel alloy and connected, for example, on a miter in the corners. In addition, strips or the like can be used as load distributors in the corners. For preassembly, the side panels 16 can be pre-attached particularly to non-discernible attachment elements, for example latching pins or the like, on the stack 13 of the battery housings 8, said attachment elements being arranged molded in plastic, for example, onto the respective battery housing 8, or the like. The side panels 14 and possibly also the cover 19 can hereby be first attached to the stack 13 and subsequently connected to one another. The components 15, 16 and 19 of the protective housing 14 can be additionally braced relative to one another by means of the tie rods 40 previously described in association with FIG. 8. In addition, the battery housings 8, which are arranged above one another in the stack 13, can be braced relative to one another by means of the tie rods 40.

In addition, FIG. 10 shows the cover 19 of the protective housing 14, said cover likewise being formed, for example, from a metallic material, for example from a sheet, just as the base 15.

It is obvious that the protective housing 14 may also be formed with other plate elements made of various materials and in different structures.

As a whole, it can thus be seen that the protective housing 14 installed in the front end 21 of the vehicle can be used similarly to the engine of conventional vehicles due to the very good position. The battery B is formed from a sealed stack 13 of battery housings 8 made of plastic in order to fill up the installation space of the engine. Because it is very important in this area to protect the stack 13 of battery housings 8 in the event of a crash, the protective housing 14 is provided from the crash-resistant sections. In addition, the protective housing 14 can contribute to the stiffness of the front end of the vehicle. In order to enable this, the metal base 15 of the protective housing 14 may be enlarged and braced as a shear panel in the underfloor area above the front end of the vehicle in order to reinforce it. Thus, the protective housing 14 can be provided with the further function of reinforcing the front end 21 of the vehicle without additional expense. Because the base 15 is an easily available integral component of the protective housing 14, no significant additional costs are expected.

1-10. (canceled)

11. A battery for an electric drive of a motor vehicle, comprising:
a plurality of battery modules which are arranged in an associated layer and are accommodated in at least one associated battery housing, wherein the battery housing is accommodated in a protective housing of the battery.

12. The battery according to claim 11, wherein a plurality of battery modules is provided, which are arranged above one another in respective layers, wherein each of the battery module layers of the battery modules is accommodated in a respectively assigned, separate battery housing, said battery housings being arranged above one another in a stack and interconnected, said stack being accommodated in the protective housing of the battery.

13. The battery according to claim 12, wherein the respective battery housing and/or the stack of battery housings is formed in a sealed manner

14. The battery according to claim 12, wherein the respective battery housing is formed from a plastic, particularly a fiber-reinforced plastic.

15. The battery according to claim 12, wherein the respective battery housing is formed in two layers with a base element and a cover element.

16. The battery according to claim 12, wherein at least a plurality of battery housings of the stack is formed with an identical shape.

17. The battery according to claim 11, wherein the protective housing has a base, which is formed as a shear panel in the underfloor area of the motor vehicle, particularly the front end of the vehicle.

18. The battery according to claim 12, wherein the respective battery housing has corresponding attachment elements for attaching respective side panels of the protective housing of the battery.
